(19) United States
(12) Patent Application Publication
(10) Pub. No.: US 2006/0282568 A1
(43) Pub. Date: Dec. 14, 2006

(54) Interface apparatus, video processing apparatus and data communication method

(75) Inventors: Ji-won Kim, Seoul (KR); Min-gu Kang, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/320,777

(22) Filed: Dec. 30, 2005

(30) Foreign Application Priority Data
May 28, 2005 (KR) 2005-0045314

(51) Int. Cl. G06F 5/00

(52) U.S. Cl. 710/52

(57) ABSTRACT

An interface apparatus between a first circuit device and a second circuit device having a first serial communication speed with an external device includes a first buffer unit to store therein data transmitted from the second circuit device; a second buffer unit to store therein data transmitted from the first circuit device; a parallel communication unit to conduct parallel communication between the second circuit device, and the first buffer unit and the second buffer unit; and a serial communication unit to conduct serial communication between the first circuit device, and the first buffer unit and the second buffer unit at a second serial communication speed faster than the first serial communication speed. With this configuration, data transmission speed between circuit devices may be enhanced.

### CROSS-REFERENCE TO RELATED APPLICATIONS

This application claims priority from Korean Patent Application No. 2005-0045314 filed on May 28, 2005, in the Korean Intellectual Property Office, the disclosure of which is incorporated herein by reference.

### BACKGROUND OF INVENTION

1. Field of Invention

The present invention relates to an interface apparatus, a video processing apparatus and a data communication method and, more particularly, to an interface apparatus, a video processing apparatus and a data communication method, capable of enhancing a speed of data transmission between circuit devices.

2. Description of the Related Art

A video processing apparatus such as a television set receives broadcasting signals of digital TV broadcasting and cable TV broadcasting from a broadcasting station, performs video processing of the received signals, and outputs video and sound.

This video processing apparatus may comprise a circuit device such as a scaler, in order to perform video processing of received video signals. In addition, the video processing apparatus may further comprise a central processing unit (CPU) to conduct overall control of the apparatus, which is capable of performing data communication with the scaler. A schematic construction of the conventional video processing apparatus is illustrated in FIG. 1.

The CPU 1 and the scaler 3 of the video processing apparatus can mutually exchange data through a data communication bus 5. The CPU 1 and the scaler 3 can exchange data according to a serial data communication method, e.g., a Gennum serial peripheral interface (GSPI). According to the GSPI, the frequency of a data clock is about 1 MHz, at which a speed of data transmission between the CPU 1 and the scaler 3 is slow, and thus, there is a risk that data such as captions which are displayed at a fast speed may be omitted. Further, it may not be so efficient as to process video data required for an on-screen display (OSD) having large capacity.

By the way, since the CPU 1 of the video processing apparatus performs overall control of the apparatus, a number of peripheral devices that the video processing apparatus requires, such as a memory (not shown), may be connected to the CPU 1. In some cases, these peripheral devices may be connected to the CPU 1, but are separated away from the CPU 1. Then, since the distance between the CPU 1 and a peripheral device is far, a phenomenon of fanout causing an error in mutual data communication may be generated.

Especially, when the CPU 1 receives a first power which is constantly supplied, and the peripheral devices receive a second power which is not supplied at a standby state in order to achieve power management, the CPU 1 may not regularly operate since the peripheral devices use the electric current of the CPU 1 in the standby state.

Further, because of an inherent property of the CPU 1, there is a limitation in the number of peripheral devices designated for data communication that are connected to the CPU 1, for example, the number of chip selects. In this connection, when an attempt is made to connect peripheral devices in excess of the limited number, there remains a problem as to how to designate the peripheral devices.

### SUMMARY OF THE INVENTION

Accordingly, it is an aspect of the present invention to provide an interface apparatus, a video processing apparatus and a data communication method, capable of enhancing a speed of data transmission between circuit devices.

Another aspect of the present invention is to provide an interface apparatus, a video processing apparatus and a data communication method, capable of preventing a phenomenon of fanout between circuit devices.

A further aspect of the present invention is to provide an interface apparatus, a video processing apparatus and a data communication method, capable of enhancing an efficiency of using circuit devices.

The foregoing and/or other aspects of the present invention can be achieved by providing an interface apparatus between a first circuit device and a second circuit device having a first serial communication speed with an external device, comprising: a first buffer unit to store therein data transmitted from the second circuit device; a second buffer unit to store therein data transmitted from the first circuit device; a parallel communication unit to conduct parallel communication between the second circuit device, and the first buffer unit and the second buffer unit; and a serial communication unit to conduct serial communication between the first circuit device, and the first buffer unit and the second buffer unit at a second serial communication speed faster than the first serial communication speed.

According to an aspect of the present invention, the interface apparatus further comprises a third buffer unit interposed between the second circuit device and the parallel communication unit, to store therein data transmitted between the second circuit device and the parallel communication unit.

According to an aspect of the present invention, the interface apparatus further comprises a buffer control unit to control operations of the third buffer unit based on a signal input from the second circuit device, so that the second circuit device receives data transmitted from the third buffer unit.

According to an aspect of the present invention, the data includes video data; the first circuit device comprises a scaler to process the video data; and the second circuit device comprises a central processing unit (CPU).

The foregoing and/or other aspects of the present invention can be achieved by providing a data communication method of an interface apparatus between a first circuit device and a second circuit device having a first serial communication speed with an external device, comprising: transmitting data from the second circuit device to the interface apparatus by parallel communication; transmitting the data transmitted from the second circuit device, to the first circuit device from the interface apparatus by serial communication at a second serial communication speed faster than the first serial communication speed; transmitting the data to the interface apparatus from the first circuit device by the serial communication at the second serial communication speed; and transmitting the data transmitted from the first circuit device, to the second circuit device from the interface apparatus by the parallel communication.

According to an aspect of the present invention, transmitting data to the second circuit device from the interface apparatus comprises: storing data transmitted from the interface apparatus in a predetermined buffer; and transmitting the data stored in the buffer to the second circuit device.

According to an aspect of the present invention, transmitting data to the second circuit device from the interface apparatus comprises: transmitting a signal to request that data be transmitted from the buffer, to the interface apparatus from the second circuit device; and transmitting a signal to enable data transmission from the interface apparatus to the buffer and then from the buffer to the second circuit device, in response to the request signal.

According to an aspect of the present invention, the data includes video data; the first circuit device,comprises a scaler to process the video data; and the second circuit device comprises a central processing unit (CPU).

The foregoing and/or other aspects of the present invention can be achieved by providing a video processing apparatus, comprising: a scaler to process video data; a central processing unit to conduct data communication with the scaler, having a first serial communication speed in serial communication with an external device; and an interface unit to conduct parallel communication with the central processing unit and serial communication with the scaler at a second serial communication speed which is faster than the first serial communication speed, to thereby interface data communication between the central processing unit and the scaler.

According to an aspect of the present invention, the video processing apparatus further comprises a buffer unit interposed between the central processing unit and the interface unit, to store therein data transmitted between the central processing unit and the interface unit.

According to an aspect of the present invention, the interface unit further comprises a buffer control unit to control operations of the buffer unit based on a signal received from the central processing unit, so as to allow the central processing unit to receive data from the buffer unit.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a block diagram to illustrate a construction of a conventional video processing apparatus;

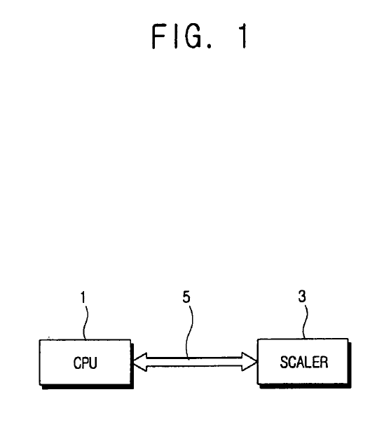

FIG. 2 is a diagram to schematically illustrate main elements of a video processing apparatus according to an exemplary embodiment of the present invention;

FIG. 3 is a diagram to illustrate a state-control register according to an exemplary embodiment of the present invention;

FIG. 4 is a circuit diagram to schematically illustrate a construction of a buffer control unit according to an exemplary embodiment of the present invention;

FIG. 5 is a flow chart to schematically illustrate an operation for a CPU to write data to a scaler according to an exemplary embodiment of the present invention; and

FIG. 6 is a flow chart to schematically illustrate an operation for a CPU to read data from a scaler according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures.

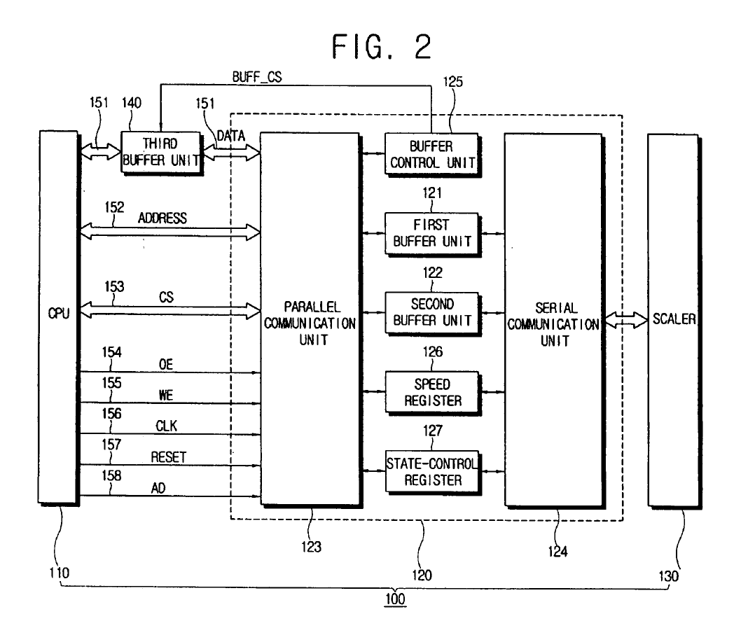

FIG. 2 schematically illustrates main elements of a video processing apparatus 100 according to an exemplary embodiment of the present invention. The video processing apparatus 100 of the present invention, which may be implemented as a plasma display panel (PDP) TV which receives video signals of analog TV broadcasting, digital TV broadcasting, and cable TV broadcasting and so on, performs video processing relative to the received video signals, and displays them with videos.

As illustrated in FIG. 2, the video processing apparatus 100 of the present embodiment comprises a CPU 110, an interface unit 120 and a scaler 130. The CPU 110 can perform overall control of the video processing apparatus 100. The scaler 130 may conduct appropriate video processing of video signals received by the video processing apparatus 100. The scaler 130 and the CPU 110 are respective examples of a first circuit device and a second circuit device of the present invention.

The CPU 110 of the present invention performs data communication with the scaler 130 through the interface unit 120. The CPU 110 is a device available both for serial and parallel communications, and the scaler 130 is a device available only for the serial communication. In the case of serial communication with the scaler 130, the CPU 110 may transmit data at a first speed of the serial communication (“first serial communication speed”). For example, when it is assumed that the CPU 110 and the scaler 130 serially conduct data transmission according to the GSPI, the frequency of a clock used in the data communication may be about 1 MHz.

The interface unit 120 conducts the parallel communication with the CPU 110, and the serial communication with the scaler 130. The interface unit 120 conducts the serial communication with the scaler 130 at a second speed of the serial communication (“second serial communication speed”) which is faster than the first serial communication speed. The interface unit 120 can conduct data communication with the scaler 130 serially according to the GSPI. In this case, the frequency of a clock used in the data communication may be about 10 MHz. It is preferable that the CPU 110 transmits more data per hour in the parallel communication, as compared to the serial communication. The data transmission speed between the CPU 110 and the interface unit 120, and that between the interface unit 120 and the scaler 130 may be similar in this exemplary embodiment.

According to the video processing apparatus according to this exemplary embodiment, the interface unit 120 is interposed between the CPU 110 and the scaler 130 whereby the serial communication by the CPU 110 is converted into the parallel communication to thereby enhance the transmitted data amount. In addition, since the interface unit 120 having superior serial communication speed conducts data communication with the scaler 130 serially, the data communication speed between the CPU 110 and the scaler 130 is enhanced.

As illustrated in FIG. 2, the interface unit 120 of this exemplary embodiment may comprise a first buffer unit 121, a second buffer unit 122, a parallel communication unit 123 and a serial communication unit 124. Data transmitted from the CPU 110 to the scaler 130 is stored in the first buffer unit 121, and data transmitted from the scaler 130 to the CPU 110 is stored in the second buffer unit 122. The first buffer unit 121 and the second buffer unit 122 of this exemplary embodiment may respectively be 16-bit buffers.

The parallel communication unit 123 conducts data communication in parallel with the CPU 110. The parallel communication unit 123 and the CPU 110 exchange signals through a data line (DATA) 151, an address line (ADDRESS) 152, a chip select line (CS) 153, an output enable line (OE) 154, a write enable line (WE) 155, a clock line (CLK) 156, and a reset line (RESET) 157, to thereby conduct parallel communication.

In this exemplary embodiment, 16-bit data may be transmitted in parallel through the data line (DATA) 151, by way of example. The address line 152 is 3 bits, to which a signal having address information to designate a buffer within the interface unit 120, such as the first buffer unit 121 and the second buffer unit 122 or a register, is transmitted. A signal to select the interface unit 120 is transmitted to the chip select line 153. A signal to inform that the CPU 110 is ready to conduct output and write operations is transmitted to the output enable line 154 and the write enable line 155. A clock signal is transmitted to the clock line 156. A signal to reset the interface unit 120 is transmitted to the reset line 157.

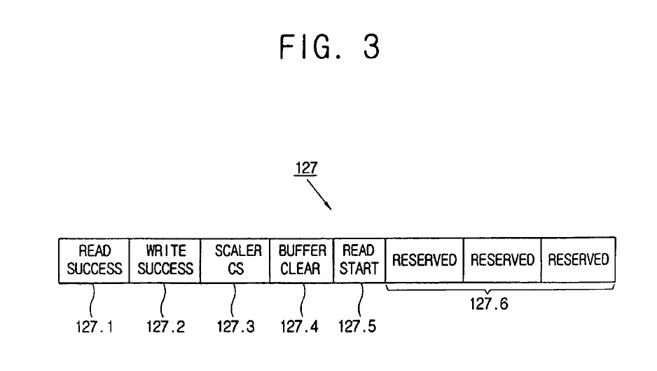

The interface unit 120 may further comprise a state-control register 127 to store therein state information and control information necessary for data communication with the CPU 110. FIG. 3 illustrates the state-control register 127. The state-control register 127 of this exemplary embodiment is an 8-bit register, which may comprise a Read Success bit 127.1 to indicate whether a read operation has succeeded, a Write Success bit 127.2 to indicate whether a write operation has succeeded, a Scaler SC bit 127.3 to select the scaler 130, a Buffer Clear bit 127.4 to clear the first buffer unit 121 and/or the second buffer unit when an error in communication is generated, and a Read Start bit 127.5 to start a read operation. The three Reserved bits 127.6 are unused bits.

The serial communication unit 124 conducts data communication serially with the scaler 130. The serial communication unit 124 and the scaler 130 may conduct the serial data communication, e.g., according to the GSPI. The interface unit 120 may further comprise a speed register 126 of 8 bits to adjust clocks, in the serial data communication between the serial communication unit 124 and the scaler 130.

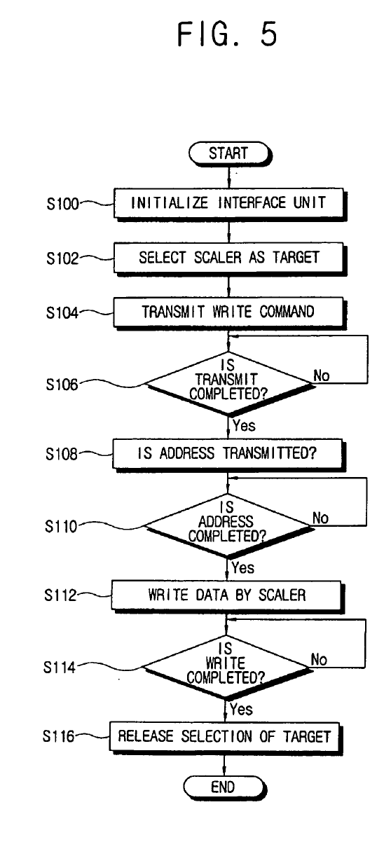

Operations of the video processing apparatus according this exemplary embodiment will be described in detail with reference to FIG. 5. FIG. 5 is a flow chart to schematically illustrate an operation for the CPU 110 to conduct data write by the scaler 130.

The CPU 110 initializes the interface unit 120 so as to write a predetermined data by the scaler 130 at operation S100. The interface unit 120 clears the Write Success bit 127.2 so as to allow the CPU 110 to conduct a next operation. The CPU 110 transmits to the parallel communication unit 123 a predetermined command to designate an object subject to the data write (“target”), and then, the interface unit 120 selects the scaler 130 as a target by adjusting the Scaler CS bit 127.3 at operation S102.

The CPU 110 transmits to the parallel communication unit 123 a 16-bit write command to indicate that the data write will be conducted at operation S104. The parallel communication unit 123 stores the received 16-bit write command in the first buffer unit 121 one bit by one bit, and the serial communication unit 124 transmits the write command stored in the first buffer unit 121 to the scaler 130 bit-serially. The interface unit 120 ascertains whether the write command has completely been transmitted to the scaler 130 at operation S106. When it is determined that the transmission has not been completed (No of S106), the interface unit 120 continues to transmit the write command. When it is determined that the write command has completely been transmitted to the scaler 130 (Yes of S106), the interface unit 120 clears the Write Success bit 127.2 so as to allow the CPU 110 to conduct a next operation.

The CPU 110 transmits data having address information of the write data to the parallel communication unit 123 at operation S108. The parallel communication unit 123 stores the received data having address information in the first buffer unit 121 one bit by one bit, and the serial communication unit 124 transmits the data having address information stored in the first buffer unit 121 to the scaler 130 bit-serially. The interface unit 120 ascertains whether the data having address information has completely been transmitted to the scaler 130 at operation S110. When it is determined that the transmission has not been completed (No of S110), the interface unit 120 continues to transmit the data. When it is determined that the data having address information has completely been transmitted to the scaler 130 (Yes of S110), the interface unit 120 clears the Write Success bit 127.2 so as to allow the CPU 110 to conduct a next operation.

The CPU 110 transmits write data to the parallel communication unit 123 at operation SI 12. The parallel communication unit 123 stores the received write data in the first buffer unit 121 one bit by one bit, and the serial communication unit 124 transmits the write data stored in the first buffer unit 121 to the scaler bit-serially. The interface unit 120 ascertains whether the write data has completely been transmitted to the scaler 130 at operation S114. If it is determined that the transmission has not been completed (No of S114), the interface unit 120 continues to transmit the write data. If it is determined that the data having address information has completely been transmitted to the scaler 130 (Yes of S114), the interface unit 120 changes the Scaler CS bit 127.3 so as to release selection of the scaler 130 at operation S 116 and conduct a next operation.

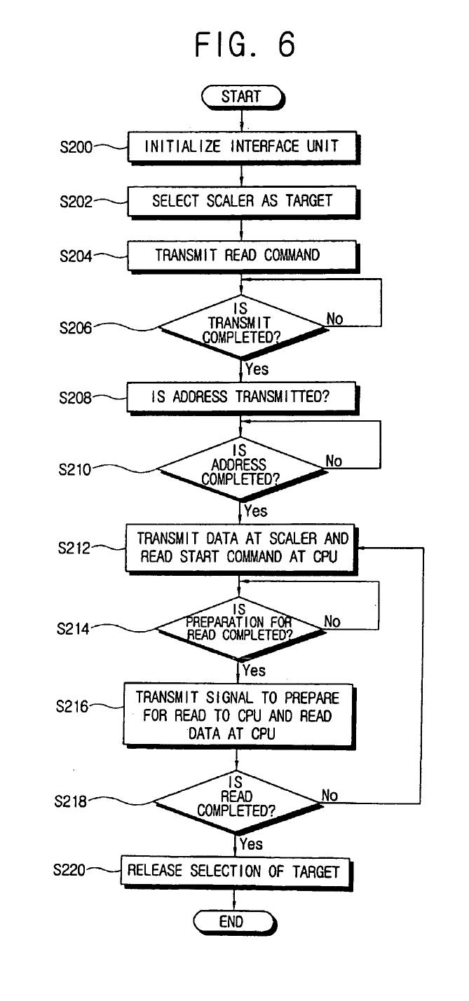

FIG. 6 is a flow chart to schematically illustrate an operation for the CPU 110 to conduct data read from the scaler 130. The CPU 110 initializes the interface unit 120 so as to a read predetermined data from the scaler 130 at operation S200. The interface unit 120 clears the Write Success bit 127.2 so as to allow the CPU 110 to conduct a next operation. The CPU 110 transmits to the parallel communication unit 123 a predetermined command to designate a target of the data read, and then, the interface unit 120 selects the scaler 130 as a target by adjusting the Scaler CS bit 127.3 at operation S202.

The CPU 110 transmits to the parallel communication unit 123 a 16-bit read command to indicate that data read will be conducted at operation S204. The parallel communication unit 123 stores the received 16-bit read command in the first buffer unit 121 one bit by one bit, and the serial communication unit 124 transmits the read command stored in the first buffer unit 121 to the scaler bit-serially. The interface unit 120 ascertains whether the read command has completely been transmitted to the scaler 130 at operation S206. When it is determined that the transmission has not been completed (No of S206), the interface unit 120 continues to transmit the read command. When it is determined that the transmit of the read command to the scaler 130 has been completed (Yes of S206), the interface unit 120 clears the Write Success bit 127.2 so as to allow the CPU 110 to conduct a next operation.

The CPU 110 transmits to the parallel communication unit 123 data having address information of read data at operation S208. The parallel communication unit 123 stores the received data having address information in the first buffer unit 121 one bit by one bit, and the serial communication unit 124 transmits the data having address information stored in the first buffer unit 121 to the scaler 130 bit-serially. The interface unit 120 ascertains whether the data having address information has completely been transmitted to the scaler 130 at operation S210. When it is determined that the transmission has not been completed (No of S210), the interface unit 120 continues to transmit the read command. When it is determined that the transmit of the data having address information to the scaler 130 has been completed (Yes of S210), the interface unit 120 clears the Write Success bit 127.2 so as to allow the CPU 110 and the scaler 130 to conduct a next operation.

Based on the read command and the address information, the scaler 130 transmits corresponding 16-bit data to the serial communication unit 124, and then the serial communication unit 124 stores the received 16-bit data in the second buffer unit 122 at operation S212. In the meantime, the CPU 110 transmits to the parallel communication unit 123 a read start command that data will be read at operation S212. The interface unit 120 checks whether the 16-bit data is completely filled in the second buffer unit 122 and determines if it is ready to be read at operation S214. The interface unit 120 determines that a preparation for read has been completed (Yes of S214), and the parallel communication unit 123 then transmits both a signal that a preparation for read has been completed and the 16-bit data stored in the second buffer unit 122 to the CPU 110, thereby allowing the CPU 110 to conduct an operation of data read at operation S216.

When it is determined that the CPU 110 has completely read the 16-bit data stored in the second buffer unit 122, the interface unit 120 clears the Read Success bit 127.1, to thereby allow the CPU 110 to receive address information of data to be transmitted next time. The interface unit 120 determines whether data read has been completed at operation S218. When it is determined that the data read has not been completed (No of S218), the interface unit 120 continues to conduct a read operation. When it is determined that the data read has been completed (Yes of S218), the interface unit 120 changes the Scaler CS bit 127.3, thereby releasing a selection of the scaler 130 at operation S220 and conducting another operation.

The video processing apparatus 100 of this exemplary embodiment may further comprise a third buffer unit 140. The third buffer unit 140 is positioned on the data transmission line 158 between the CPU 110 and the parallel communication unit 123, and temporarily stores therein data transmitted between the CPU 110 and the parallel communication unit 123. The third buffer unit 140 functions to prevent the phenomenon of fanout, whereby an error in mutual data communication between the CPU 110 and the parallel communication unit 123 is not generated.

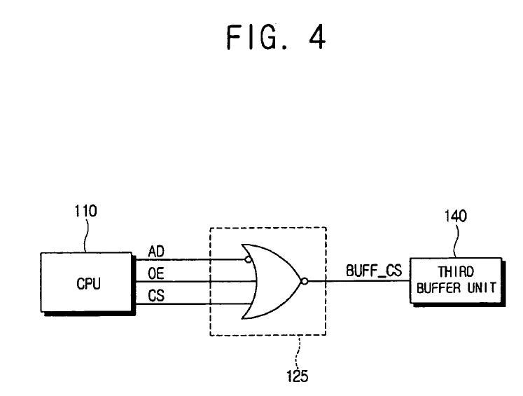

The interface unit 120 may further comprise a buffer control unit 125 to select the third buffer unit 140 as a target by transmitting the chip select signal (BUFF-CS) to the third buffer unit 140. FIG. 4 schematically illustrates a construction of the buffer control unit 125 of this exemplary embodiment. Referring to FIG. 4, the buffer control unit 125 may be implemented as a NOR circuit. The buffer control unit 125 may receive a signal to request that the third buffer unit 140 be selected as a target, from the CPU 110 by way of the parallel communication unit 123.

The CPU 110 of this exemplary embodiment may further comprise a buffer designate line (AD) 158, and may transmit three signals AD, OE and CS as signals to request that the third buffer unit 140 be selected as a target, through the buffer designate line 158, the output enable line 154 and the chip select line 153. The buffer control unit 125 receives these three signals AD, OE and CS and transmits NOR values thereof as the chip select signal BUFF-CS of the third buffer unit 140. The buffer control unit 125 may transmit the chip select signal BUFF-CS to the third buffer unit 140, whereby the third buffer unit 140 is directed toward the CPU 110 from the interface unit 120, when the CPU 110 as designated reads out data from the scaler 130. According to this, when the third buffer unit 140 cannot be selected directly by the CPU 110 through the chip select signal CS since a number of peripheral devices are connected to the CPU 110, the third buffer unit 140 may be selected, as an indirect method, through the buffer control unit 125 by transmitting the chip select signal BUFF-CS, thereby efficiently utilizing given circuits.

The interface unit 120 may be implemented as a complex programmable logic device (CPLD), by way of an example of an interface apparatus according to the present invention. The third buffer unit 140 is an example of the buffer unit of the present invention, which may be comprised in the interface apparatus of the present invention.

As described above, the present invention provides an interface apparatus, a video processing apparatus and a data communication method, capable of enhancing a speed of data transmission between circuit devices.

The present invention further provides an interface apparatus, a video processing apparatus and a data communication method, capable of preventing a phenomenon of fanout between circuit devices.

The present invention also provides an interface apparatus, a video processing apparatus and a data communication method, capable of enhancing an efficiency of utilizing circuit devices.

Those of ordinary skill in the art can understand that various replacements, modifications and changes in form and details may be made therein without departing from the spirit and scope of the present invention as defined by the following claims. Therefore, it is to be appreciated that the above described embodiment is for purposes of illustration only and not to be construed as a limitation of the invention.

What is claimed is:

1. An interface apparatus between a first circuit device and a second circuit device having a first serial communication speed with an external device, comprising:
a first buffer unit to store therein data transmitted from the second circuit device;
a second buffer unit to store therein data transmitted from the first circuit device;
a parallel communication unit to conduct parallel communication between the second circuit device, and the first buffer unit and the second buffer unit; and
a serial communication unit to conduct serial communication between the first circuit device, and the first buffer unit and the second buffer unit at a second serial communication speed faster than the first serial communication speed.

2. The interface apparatus of claim 1, further comprising a third buffer unit interposed between the second circuit device and the parallel communication unit, to store therein data transmitted between the second circuit device and the parallel communication unit.

3. The interface apparatus of claim 1, further comprising a buffer control unit to control operations of the third buffer unit based on a signal input from the second circuit device, so that the second circuit device receives data transmitted from the third buffer unit.

4. The interface apparatus of claim 1, wherein the data includes video data;
the first circuit device comprises a scaler to process the video data; and
the second circuit device comprises a central processing unit (CPU).

5. A data communication method of an interface apparatus between a first circuit device and a second circuit device having a first serial communication speed with an external device, comprising:
transmitting data from the second circuit device to the interface apparatus by parallel communication;
transmitting the data transmitted from the second circuit device, to the first circuit device from the interface apparatus by serial communication at a second serial communication speed faster than the first serial communication speed;
transmitting the data to the interface apparatus from the first circuit device by the serial communication at the second serial communication speed; and
transmitting the data transmitted from the first circuit device, to the second circuit device from the interface apparatus by the parallel communication.

6. The data communication method of claim 5, wherein transmitting data to the second circuit device from the interface apparatus comprises:
storing data transmitted from the interface apparatus in a predetermined buffer; and
transmitting the data stored in the buffer to the second circuit device.

7. The data communication method of claim 5, wherein transmitting data to the second circuit device from the interface apparatus comprises:
transmitting a signal to request that data be transmitted from a buffer, to the interface apparatus from the second circuit device; and
transmitting a signal to enable data transmission from the interface apparatus to the buffer and then from the buffer to the second circuit device, in response to the request signal.

8. The data communication method of claim 5, wherein the data includes video data;
the first circuit device comprises a scaler to process the video data; and
the second circuit device comprises a central processing unit (CPU).

9. A video processing apparatus, comprising:
a scaler to process video data;
a central processing unit to conduct data communication with the scaler, having a first serial communication speed in serial communication with an external device; and
an interface unit to conduct parallel communication with the central processing unit and serial communication with the scaler at a second serial communication speed which is faster than the first serial communication speed, to thereby interface data communication between the central processing unit and the scaler.

10. The video processing apparatus of claim 9, further comprising a buffer unit interposed between the central processing unit and the interface unit, to store therein data transmitted between the central processing unit and the interface unit.

11. The video processing apparatus of claim 10, wherein the interface unit further comprises a buffer control unit to control operations of the buffer unit based on a signal received from the central processing unit, so as to allow the central processing unit to receive data from the buffer unit.
